(19) United States
(12) Patent Application Publication
(10) Pub. No.: US 2020/0210954 A1
(43) Pub. Date: Jul. 2, 2020

(54) Heterogeneous Data Management Methodology and System

(71) Applicant: TraxID,LLC, Dallas, TX (US)

(72) Inventor: Duke Loi, Frisco, TX (US)

(21) Appl. No.: 16/237,668

(22) Filed: Dec. 31, 2018

(51) Int. Cl. G06Q 10/10; G06Q 10/06; G06Q 30/04; G06Q 30/08; G06Q 10/00; G06F 16/28; G06F 16/25

(52) U.S. Cl. CPC G06Q 10/103; G06Q 10/06313; G06Q 30/04; G06F 16/25; G06Q 10/20; G06F 16/284; G06Q 30/08

(57) ABSTRACT

A system for storing, interpreting, displaying, and processing heterogeneous data comprises a common data layer configured to manage and store abstracted data using a standard relational database, the common data layer comprises a template repository storing a plurality of data-logic templates and user data. The system further includes a data abstraction layer comprising rules for processing user data and handling a user-interface, an intelligence layer comprises context sensitive processing logic of user inputs and data from the data abstraction layer according to the data-logic templates, and a user interface layer configured to present the processed data and capture user inputs for the system.

### RELATED APPLICATION

The present application is a Continuation-in-Part of U.S. application Ser. No. 15/666,550 filed on Aug. 1, 2017, and entitled “Heterogeneous Data Management Methodology and System”, which is a continuation-in-part of U.S. application Ser. No. 14/206,455 filed on Mar. 12, 2014, which claims the benefit of U.S. Provisional Application No. 61/791,046 filed Mar. 15, 2013. This application also claims the benefit of U.S. Provisional Application No. 62/403,599 filed Oct. 3, 2016, and entitled “Oil and Gas Tubular Goods Inspection Analysis Methodology. All of the disclosures in these applications are incorporated herein by reference.

### FIELD

The present disclosure primarily relates to a heterogeneous data management methodology and system, and application of this technology to a novel oil and gas tubular goods inspection analysis methodology and system.

### BACKGROUND

In traditional software design, datasets are created specifically for predefined data fields and types. In order to manage heterogeneous data in a system, either multiple datasets are created for different data types, or a large dataset is used to encompass all possible data fields of every possible data types. These approaches are inefficient and inflexible to change.

Inspections for oil-country-tubular-goods (OCTG), drill tools, and bottom-hole-assemblies (BHA) are typically done discretely without much analysis and comparison. Inspection data are mostly recorded on paper or computer devices with limited capabilities. Results are often used to satisfy the safety and operation requirements for drilling purposes but not so much on improving products, manufacturing, and management processes. Therefore, product deficiencies and operations limitations are not effectively analyzed, compared, and provided as feedback to manufacturers.

### DESCRIPTION OF THE DRAWINGS

FIG. 1 is a block diagram illustrating the architecture of the heterogeneous data management methodology and system according to the teachings of the present disclosure;

FIG. 2 is a block diagram illustrating an exemplary dynamically mapped dataset of the heterogeneous data management methodology and system according to the teachings of the present disclosure;

FIG. 3 is a block diagram illustrating an exemplary format for the data record or data table of the heterogeneous data management methodology and system according to the teachings of the present disclosure;

FIG. 4 is a diagram illustrating an exemplary detail data section record or table of the heterogeneous data management methodology and system according to the teachings of the present disclosure;

FIGS. 5-7 are screen captures of exemplary data displays according to the to the teachings of the present disclosure;

FIG. 8 is a diagram illustrating an exemplary general data section record or table of the heterogeneous data management methodology and system according to the teachings of the present disclosure;

FIG. 9 is a simplified block diagram of an exemplary environment in which the heterogeneous data management methodology and system are adapted to operate; and

FIG. 10 is a simplified block diagram of an exemplary oilfield inspection system having a plurality of logic modules built on the heterogeneous data management system according to the teachings of the present disclosure.

### DETAILED DESCRIPTION

A new and unconventional system and method of managing heterogeneous data is described in this disclosure. This heterogeneous data management methodology enables a software system to manage and store heterogeneous data homogeneously in a single system and data structure. For example, different work order types with different data sizes can be stored in the same common data layer. Storage utilization is maximized by only storing data fields that are relevant to the assets or work orders. Adding new assets (e.g., oil well, motor, pipe) or work order types (e.g., service motor, inspect pipe, install motor, etc.) does not require a complete makeover of the database tables, but instead, the addition can be handled dynamically and incrementally without taking the entire system offline. Thus, this methodology provides great expandability and adaptability to system implementation. Furthermore, the intelligent data management layer provides additional data abstraction and protection.

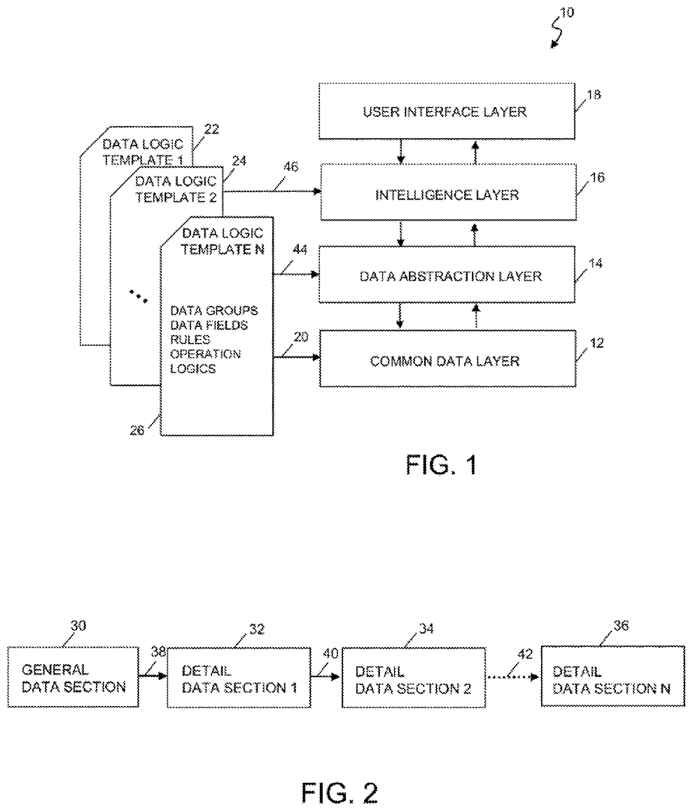

This software methodology 10 for managing heterogeneous asset and work-order data includes four functional layers: common data layer 12, data abstraction layer 14, intelligence layer 16, and user interface layer 18. These layers 12-18 are primarily driven by data-logic templates 20-24 which are defined for each asset and/or work order type, as shown in FIG. 1.

Each data-logic template 20-24 defines the data groups, data fields, business rules, and operation logics for an asset category or work order type. Thus, one system uniformly manages multiple categories of assets and work order types, and enables cross-template updates according to their predefined rules and operation logics. Adding a new asset category or work order type to an existing system is possible by adding a new template. In short, a data-logic template defines how the system should handle an asset category or work order type, and how the data of one template interacts with other templates.

Therefore, data are validated and processed according to a data-logic template of a specific data object type, data are also abstracted according to a data-logic template of a specific data object type, and data are extracted based on extracting rules that are defined in a data-logic template of a specific data object type.

The first layer is the common data layer 12 which manages and stores abstracted data using standard relational database system. It includes a template repository and user data. The template repository stores all data-logic templates 20-24 of the system 10. The system 10 uses these data-logic templates 20-24 to create screens, tabs, and data fields at the user interface layer 18, and to process the data at the intelligence layer 16. The user data is structured and stored according to the database schemas 20 of the data abstraction layer 14 and the data-logic templates 22-26.

User data of different data object types are encoded and stored in the same set of common database tables. Each data record is stored in a dynamically mapped dataset which contain a general data section 30 and one or more linked detail data sections 32-36, as shown in FIG. 2. Detail data sections 32-36 are linked to the general data section 30 and to one another by the detail section pointers 38-42. The general purpose of the General Data Section 30 is to provide the system a consistent way to process and search all work orders regardless of their work order types. Thus, data fields within the General Data Section 30 are consistently named and defined. The general data section 30 contains key data fields that are used by the system to identify, locate, and interpret subsequence detail datasets. The detail data sections contain data-logic defined datasets that can only be interpreted by data-logic template definitions.

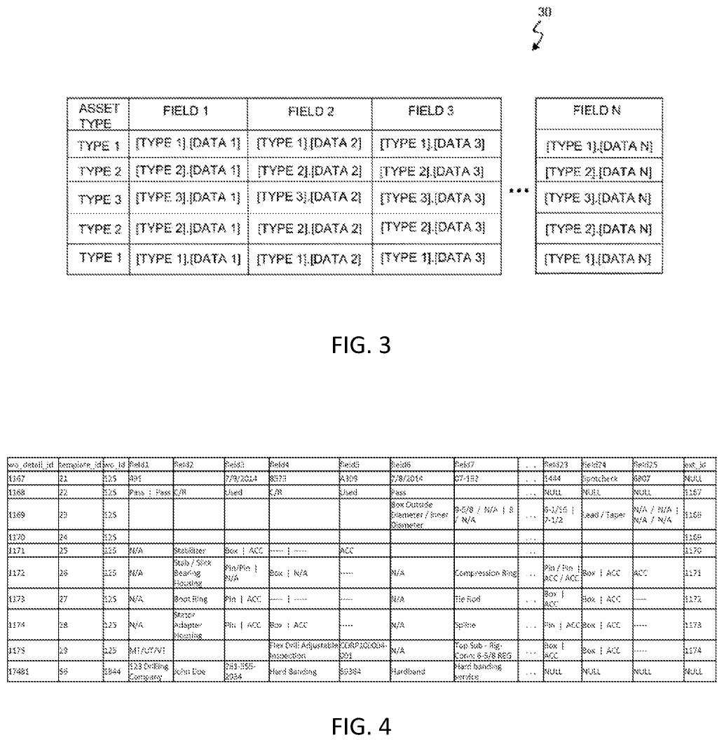

FIG. 3 is an exemplary drawing of a detail data section which illustrates the same database column can store different data from different data object types with different data types and attributes. For example, a drill pipe data object type and a mud motor data object type can store different data in the same database column of the same database table.

The layer above the common data layer 12 is the data abstraction layer 14. It provides rules to the layers 16 and 18 above for processing user data and handling the user-interface. In addition, it encodes and decodes user data to and from the common data layer 12 according to the data definitions 44. The data abstraction layer 14 places a field name and rules to a detail field and allows the layers above to correctly process the data. The data abstraction layer 14 allows different types of data stored in the same database column for different asset or work order types, as shown in FIG. 3. Thus, this data storing method maximizes the database table utilization and enables new addition of asset categories and work order types without adding database tables and the programming changes to the existing system.

The intelligence layer 16 provides context-sensitive logic and processing of user input and data from the data abstraction layer 14 according to the data-logic templates 22-26. The data processing includes, but not limited to, data validation, data updates/postings, calculations, screen controlling, and report generation. The intelligence layer 16 retrieves data and screen processing rules 46 dynamically from the corresponding template 24 on demand.

The last layer of the model is the user interface layer 18 which presents the processed data and captures user inputs for the system. The screen and field layouts are controlled by the intelligence layer 16 based on the data-logic template definition 46 of an active asset category or work order type. A system can have different screen layouts and data fields for different asset categories and/or work order types. This simplifies and unclutters the screens, and only presents necessary information to the user.

Different work order types with different data sizes can be stored in the same common data layer 12. FIG. 4 is an exemplary work order detail 32-36 that contains data records from two different work order types: tool inspection and tool servicing. This tool inspection work order type example has many data fields, which occupies 9 rows of record and each record contains 25 data fields and system controlling fields. By looking at the rows of data in the common data layer 12, field1 from one row has no corresponding meaning to field1 in another row. For example, field1 of first row contains a serial number of an inspection coil, and field1 of second row contains inspection results of an asset. Further, field1 of the last row contains a customer name of a service work order.

The data abstraction layer 14 interprets or manages each data field according to the predefined definition of the templates 26. Thus, the system controls where to save the data, how to display them, and what business logics should be applied to them. Without the data abstraction layer 14 and the corresponding templates 26, the system would not know how to manage the data, and all data become meaningless to the system and the users. Above the data abstraction layer 14, the intelligence layer 16 applies data processing logics and formatting rules 24 to the data when they are entered by the user or retrieved from the system. The intelligence layer 16 performs according to the corresponding template and instructs the user interface layer 18 on how to display the data and their field labels.

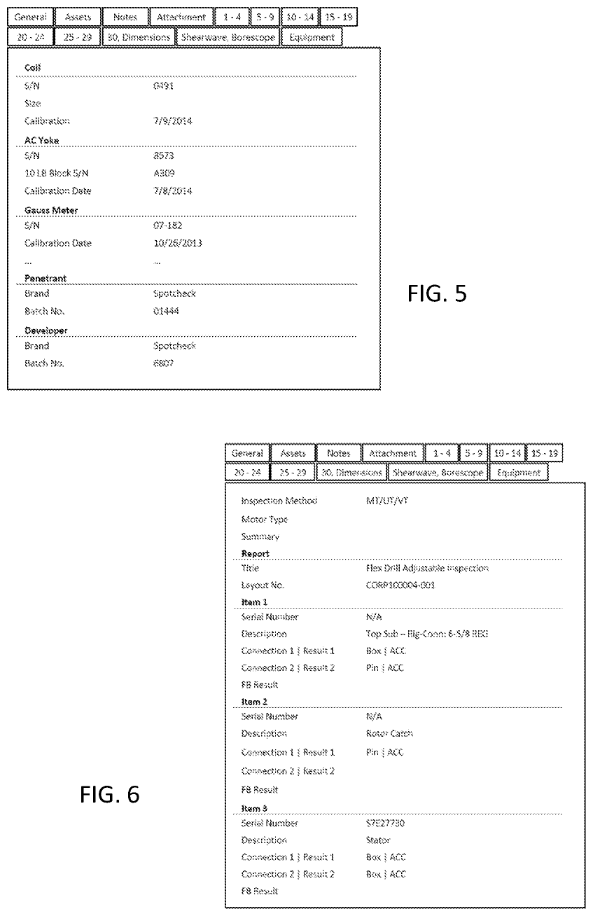

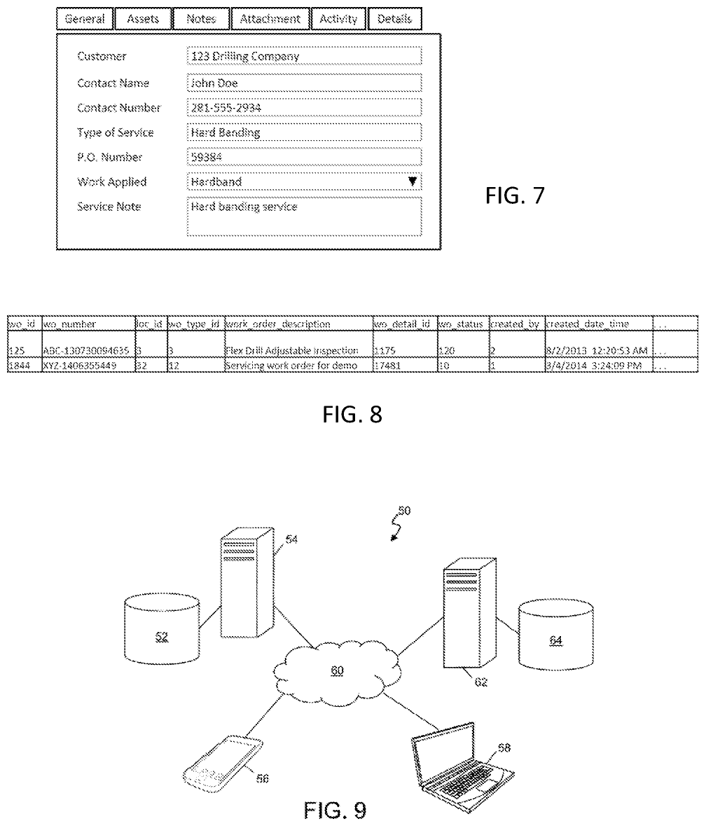

As shown in FIGS. 5-7, the data from the previous example are displayed differently according to the templates. The data from field1 of the first row in FIG. 4 is shown as serial number under the “Coil” section with the field label of “S/N.” The data from field1 of row 9 (second to last row) in FIG. 4 is shown and interpreted as a method of inspection in FIG. 6, and displayed with the field label of “Inspection Method.” These fields are displayed as read-only fields due to the definitions of Tool Inspection work order template. However, data from field1 of last row in FIG. 4 is shown as customer name in FIG. 7 with the field label of “Customer.” This field is read/write field to permit the user to enter or edit the data as it is defined in Service work order template.

FIG. 4 illustrates a Detail Data Section as shown in FIG. 2. The Detail Data Sections 32-36 can be one or many as defined in each template. Thus, the General Data Section 30 allows the system to find the Detail Data Sections 32-36 by linking them, as shown in FIG. 2 and FIG. 8 below. FIG. 8 illustrates the General Data Section 30 with a common system data field for work orders and the Detail Data Section link in work order detail ID field (wo_detail_id). In the first row of the data record shown in FIG. 8, the work order detail ID has a value of 1175 (not shown in the table) which links to row 9 (second to the last row) of FIG. 4. The extension field (next to last field) in row 9 links to 1174 which is the row right above it. The links continue until reaching the first row of FIG. 4 which has a value of NULL, that is the end of the Detail Data Section for that particular work order with Tool Inspection work order type. FIGS. 5-7 show various detail data tabs on the screen (after the Activity tab). They are shown because of the Intelligence Layer and the Tool Inspection work order template. The Intelligence Layer relays the template definition to the User Interface Layer which draws the corresponding tabs, field labels, field, titles, and their formats.

The general purpose of the General Data Section 30 is to provide the system a consistent way to process and search all work orders regardless of their work order types. Thus, data fields within the General Data Section 30 are consistently named and defined; i.e. second field of row 1 has the same data type as row 2, where both are work order numbers, for example.

FIG. 9 is a simplified block diagram of an exemplary environment 50 in which the heterogeneous data management methodology and system are adapted to operate. The database 52 in which user data and data-logic templates are stored may be accessed by a server 54, which is further accessible by users using various types of computing devices 56 and 58, which may be, for example, mobile telephones, tablet computers, GOOGLE glasses, laptops, desktop computers, and other forms of computing devices now known and later developed. The communication medium 60 may be wired and wireless, and implement any number of known and future communication protocols. The communication medium 60 may be part of a local area network, wide area network, the Internet, and other computer networks. The database 52 and server 54 may be mirrored in one or more servers 62 and databases 64.

The present disclosure relates to a heterogeneous data management system that comprises data-logic templates which defines: how different data types are stored and managed in common database tables for different assets or work orders; data sets that include field names, data types, data attributes, and rules for each types of assets or work orders; and data interaction between work order data and asset data.

The present disclosure relates to creating new screens and data fields by importing a data-logic template file without programming or database changes.

The present disclosure relates to different data fields that are stored in common database tables that are shared by different object types (i.e. assets or work orders) at the common data layer.

The present disclosure relates to data abstraction layer that applies data field names, data types, data attributes, and rules to the raw data in common data layer based on predefined data-logic template of a specific asset or work order type. The present disclosure relates to an intelligence layer that manages how data fields interact with each other based on the data-logic templates. The present disclosure relates to a user interface layer that presents each data field according to data-logic template definition and how the system validates the user input.

The present invention describes the methodologies to analyze oil and gas tubular goods inspection data which were collected from non-destructive testing and various types of inspections. Inspections includes but are not limited to magnetic particle inspection, ultrasonic testing, liquid penetrant inspection, visual inspection, radiographic testing, and measuring and comparing dimensions of components. Inspection results are captured and recorded on a sophisticated inspection system that includes field inspection computer tablets or laptops, and a centralized cloud-based portal system. Past and current data from multitude inspection sites are centrally stored and analyzed. Detail and aggregate views of the stored inspection data over time are correlated with drilling information, various analytical trends are generated to assist manufacturers, drilling operators, oil companies to improve products and services. By using a well-defined inspection software system described herein, detail inspection data can be captured and retained in the systems indefinitely; and therefore, can be analyzed in a way that has not been done before.

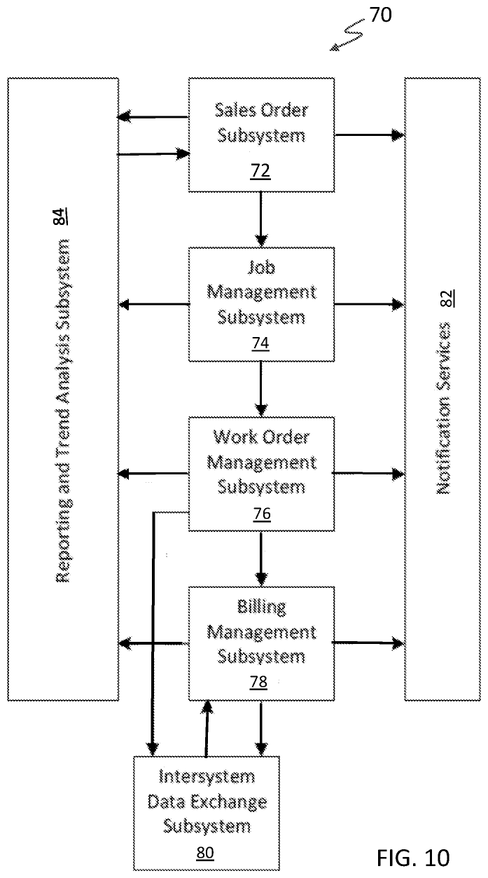

FIG. 10 is a simplified block diagram of an exemplary oilfield inspection system 70 having a plurality of logic modules/subsystems 72-84 built on the heterogeneous data management system according to the teachings of the present disclosure. These logic modules/subsystems 72-84 are designed and built on the heterogeneous data management software architecture described herein, which enables different types of data to be stored in a database and shared between the logic modules or subsystems. Predefined functional and data templates allow data between subsystems to be managed effectively by referencing the templates without extensive code changes. The adaptability of the database connects these logic modules seamlessly and improves their functional adaptability.

FIG. 10 describes the interrelationship of the logic modules also referred herein as subsystems of an oilfield inspection system 70. Sales Order subsystem 72 provides a consolidated decision-making web portal or app on tablets or laptop computing devices for sales personnel working in the field to make quick decisions and generate bids or quotations for inspection jobs. The relationship of sales orders, jobs, and work orders enable the reporting and trend analysis subsystem 84 to analyze the works from sales orders or bids to jobs and then to the actual works within the same system. The heterogeneous data management system 10 allows the system to store and analyze data from different phases of work processes with different types of works and assets. Sales orders can be created in Sales Order subsystem 72 and converted into a job upon approval of the sales order in Job Management subsystem 74. Both the sales order and the job can include multiple work items with different inspection types and asset types which are used to create inspection work orders in Work Order Management subsystem 76. By assigning a data-logic template to job items within a job, it enables Job Management subsystem 74 to create work orders with different asset types and inspection work order types within the same job. When creating work orders, the system uses the data-logic templates 22, 24, 26 to create the work orders with the correct data fields, validation logic, screens, and business rules for each inspection types. This allows a job to manage multiple work orders where each work order is linked to the originating job in the Job Management subsystem 74 and also back to a sales order in the Sales Order subsystem 72.

Every inspection work order created from the present system and method captures all necessary equipment's serial numbers, manufacturers, models, last calibration dates, and setup and calibration measurements. Some equipment require multiple subsystems and yet others may require as simple as a micrometer or a profile gauge. Equipment with multiple subsystems may need complex setup where the setup parameters are essential to the inspection integrity of the items. For example, the setup of an EMI unit requires longitudinal and transverse gain settings, gamma settings, and other settings. Once the equipment is set up, the system needs to run through several control items to confirm the settings. The present system and method comprise methodologies to analyze the equipment integrities for different types of inspections, creates maintenance and calibration plans for the equipment, life expectancy of those equipment, and the costs associating to those equipment for the inspections. This information is important to accurately measure the operation costs and the profit for the inspections, and aids sales personnel in pricing new jobs. Equipment downtimes and usages are tracked and measured against the work orders in order to understand the impact of each inspection types toward the corresponding equipment.

When work orders are approved by a user, tickets and/or invoices can be automatically generated in the Billing Management Subsystem 78. Data-logic templates 22, 24, 26 provide business rules to Billing Management subsystem 78 on how to automatically post work orders into tickets or invoices. Some work order types post each work order as a single entry into field a ticket or invoice; whereas other work order types post individual work items within a work order as separate entries to a field ticket or invoice. For example, a drilling motor inspection work order posts the entire work order, which has multiple components, to a field ticket or invoice as a single invoice entry, but a bottom-hole assembly inspection work order posts each work items within a work order as separate items to an invoice. Furthermore, billing management subsystem 78 uses different rules to calculate the prices for different work order types. The pricing rules for inspecting a drilling mud motor is entirely different than the pricing rules of inspection a multitude of drill pipe. It includes the main prices, as well as, calculating the supplementary prices per item and per types of inspection method uses. This is possible because of the data-logic templates for each work order types and the intelligence layer 16, even though all work order data are stored in same sets of data tables within the common data layer 12.

The process also allows field managers and billing personnel to obtain all necessary approvals from customers. Some field inspection jobs require approval stamps at the inspection site and others require proper purchase order and job numbers from customers after reviewing work order reports and tickets. The Notification Services Subsystem 82 automatically notifies billing personnel and operation managers whenever invoices are approved or rejected by customers. It allows rejected invoices to be handled immediately and shorten the delay for receivables. Once invoices are approved by a user, they are posted in batches into a backend accounting system via the Intersystem Data Exchange Subsystem 80. All related reports, tickets, invoices, inspection data, pictures, attachments are also sent to interested recipients via emails.

Inspection results from different inspection methods and asset types are stored in the same sets of database tables within the common data layer 12. The reporting and trend analysis subsystem 84 can perform datamining and data analysis of the relevant data across different asset types and inspection work order types according to the data-logic template 22, 24, 26. Hence, damages such as cracks, damaged shoulder, damaged thread, eccentric wear, bent, etc. can be analyzed in drill pipe inspection, drill collar inspection, drilling mud motor inspection, and so on. Even though damages may occur on different asset types and discovered via different inspections, but reporting and trend analysis subsystem 84 is able to draw conclusion and/or projection for drilling operator practices, oilfield formation characteristics, equipment reliability based on similar damages observed. Heterogeneous data management system 10 allows software solutions to collectively capture, understand, and analyze similar data without changing the analysis models or data mapping to other data tables or databases.

Work Order Management subsystem 76 is capable of automatically handling different types of inspections of different types of assets. Hence, the same software system can document inspection of drill pipes based on, for example, American Petroleum Institute (API) inspection methods and standards, and can also document inspections of drilling mud motor based on, for example, Standard DS-1 specifications. Different sets of measurements are required to be captured and following different processes to determine if the inspected items passes or fails the inspection. The API drill pipe inspection measurements include wall thickness, outside diameter, shoulder width, and tong space; whereas DS-1 drilling mud motor inspection measurements include bevel diameter, bore-back, thread and seal conditions for every component within a drilling mud motor. Furthermore, a drill pipe inspection work order contains hundreds of drill pipes that are being inspected individually within the same work order/job, but a drilling mud motor inspection work order only contains one main item with many components that make up the drilling mud motor and are also being inspected. Via the heterogeneous data abstraction layer 14, Work Order Management subsystem 76 is able to store and interpret different data on the same set of data tables in the common data layer 12. The Work Order Management subsystem 76 can handle a completely new work order type (i.e. pipeline inspection) by importing a new data-logic template 22, 24, 26 for that work order type without adding new database tables or modifying existing tables to handle the new data. In addition, Work Order Management subsystem 76 can be extended to support proprietary data, workflows, and grouping of work processes into the same work order type, i.e., grouping drill pipe inspection with workforce management by clocking in/out of inspectors in the field and uploading hours and issues to payroll system and issue management system.

Work Order Management subsystem 76 is capable of storing coded inspection results for later analysis by the Oil and Gas Tubular Goods Inspection Analysis system (U.S. Provisional Patent Application No. 62/403,599 filed on Oct. 3, 2016). Various inspection results can be coded in a standardized format for different inspection work order types. Users can select a combination of result codes through the User Interface Layer 18 while inspecting items and the Intelligence Layer 16 processes the selections according to the Data Logic Template 22, 24, 26 for different inspected areas and items within the same work order. For example, a drill pipe inspection work order can have damaged thread (coded to DT) and cracked (coded to CRK) result codes for the box connection, bent (coded to BT) for the tube, and eccentric wear (coded to ECC) and damaged seal (coded to DS) for the pin connection of the same drill pipe while other drill pipe have different combination of result codes in the same work order. Each inspected area of an item can have as many damaged codes as applicable.

Furthermore, different types of items within the same work order can have different features or areas to be inspected, which have different combinations of result codes. For example, a bottom-hole-assembly (BHA) inspection work order can have a drill collar with pin and box connections, a drill sub with box and box connections, or a stabilizer with blades. All have different combinations of result codes for different features of the items and all stored at the same location within the database that is made possible by the Data Abstraction Layer 14 according to the Data Logic Templates 22, 23, 24. By storing the results in the same location enables the analysis to be done effectively across different types of work orders, materials, and features of the materials. For example, the result stored in field 10 in a database may mean the result codes for a box connection of a drill pipe in a drill pipe inspection work order, and at the same field 10 of a different record may be the result codes for one of the blades of a stabilizer in a BHA inspection work order. The Oil and Gas Tubular Goods Inspection Analysis system will retrieve the codes and analyze them according the corresponding Data Logic Template 22, 24, 26 of each item in the Data Abstraction Layer 14 and Common Data Layer 12.

Similarly, the measurements of the features of the inspected items for various inspection work order types are processed and mapped according to the Intelligence Layer 16 and Data Abstraction Layer 14 for later analyzed by the Oil and Gas Tubular Goods Inspection Analysis system. The number of measurements are endless for every type of material and inspection types. For example, for drill pipe inspection work order, a measurement of wall thickness and bevel diameters along with other measurements must be recorded according to the American Petroleum Institute (API) standards. Based on the drilling location, some companies require the measurement in Imperial format and others require the measurement in metric format. Regardless of the types of measurements for different materials and inspection types, the Oil and Gas Tubular Goods Inspection Analysis system relies on the Intelligence Layer 16 and Data Abstraction Layer 14 and the corresponding Data Logic Template 22, 24, 26 to retrieve and interpret the measurements for comparison and analysis.

Captured inspection results and measurements are validated in Work Order Management subsystem 76 based on the inspection rules and standards defined in the intelligence layer 16. Work Order Management subsystem 76 also displays warnings and calculations to inspectors via the user interface layer 18 according to each data-logic template 22, 24, 26 for various types of inspections. For example, wall thickness measurement of a drill pipe is essential to pass a drill pipe inspection of each drill pipe; however, it is not required for inspecting a drill collar. By selecting inspection work order types, the software system internally decides which data-logic template 22, 24, 26 to use for validating the required data fields and/or calculations. This provides flexibility to changing validation rules and customizing inspection types.

The Reporting and Trend Analysis subsystem 84 captures and analyzes historical bids and jobs that are similar to the current job being bid on and feeds the data into the Sales Order subsystem 72 in order to recommend bids to the sales personnel, as well as provide data on potential risk factors. Once a bid is generated, Sales Order subsystem 72 automatically tracks the bidding progress and updates the user throughout the lifecycle of that bid. It automatically sends notification messages or emails via the Notification Services subsystem 82 to the corresponding personnel, as well as generating tracking reports for upper management. All bids are also tracked and rated by the Notification Services dashboards. The Notification Services 82 has a suite of services that automatically process and manage notifications sent to users, managers, vendors, customers, and subsystems depending on the context of the messages and the originating subsystem. More importantly, it has a web-based dashboard for managers and executives to have consolidated access to high-level information for quick business and operation decisions. Once customers accept the bids, the Job Management Subsystem 74 tracks them as pending jobs and provides operation metrics for operation managers. Operation managers will have in-depth visibility of each job and tools to schedule and approve jobs for work by personnel. Approved jobs generates work orders in the Work Order Management Subsystem 76 and operation managers can assign them to inspectors or inspection lines. Work orders are automatically tracked throughout the subsystem, which sends notifications to related personnel throughout the entire work process to report work status. Work status includes:

Work assignments—notify inspectors about the pending works and their schedules and work instructions and travel information for field jobs.

Work reassignments—whenever work orders are reassigned to other inspectors or inspection lines.

Work completions—whenever work orders are completed and ready to generate tickets.

Work approvals or rejections—notify related individuals to promptly address rejected work orders, and allowing billing personnel to create invoices for approved work orders.

Non-work incidents—notify operation managers about non-work incidents in the field that may affect work schedules and resources, such as bad weather, equipment issues, safety concerns, personnel absences, logistics issues, etc.

Sending inspection reports, field tickets, and invoices for all completed work orders are governed by sets of business rules within the intelligence layer 16 according to the data-logic templates 22, 24, 26 for different types of work orders and process state of the work orders. For example, upon completing and approving of a work order, Notification Services 82 may immediately collect all needed data by the external system via the data abstraction layer 14 and the corresponding data-logic template 22, 24, 26 for that work order type. With the confirmation from intelligence layer 16 based on the business rules from the data-logic template 22, 24, 26, the notification services 82 groups and sends emails with report attachments to certain recipients. In addition, pushing inspection results to other external systems includes intricate tasks of getting the correct data at the correct state of the work orders. External systems may include other ERP systems, inventory management systems, and financial systems. Each external system requires different set of data and the method of delivery. For example, a financial system only be interested of invoice data and the inspection reports of the work order; whereas an inventory management system is interested to receive inspection results per asset serial numbers and the frequency of inspections. Some external system requires the data to be pushed to the system and other may be interest to obtain exported files.

Intersystem Data Exchange Subsystem 80 supports many data integration roles beside posting invoices. It is able to download financial information from backend systems to accurately measure works and revenue progresses and projections. It can also push inspection results to customers' databases via the Internet.

Reporting and Trend Analysis Subsystem 84 collects and measures jobs, revenues, inspections, user activities, and device data throughout the subsystems. It provides the ability to perform data mining to generate in-depth data analysis and trends from data that may not appear to be related at first glance. Inspection analysis may include: (1) inspected damages, (2) inspection frequencies, (3) reliability and life-expectancy, (4) additional services rendered during inspection, (5) component deterioration over time. Operations analysis may include: (6) operation efficiency, (7) market penetrability, (8) product-line return-on-investment. The damages can be recorded for any feature of a component during inspection. For example, a drilling motor has many components and each component has a plurality of features or areas of inspections. Similarly, a drill pipe has several different features, e.g., box connection, pin connection, and tube. As another example, an 8-inch drilling motor has a stator component which has a pin feature that may has damage that is uncovered during inspection.

By aggregating the damages for a group of items, the system can generate a pie chart of damages that have been identified from the inspection based on the search criteria and rank the damages by percentage of occurrence. This information informs both management and manufacturer of how often a certain component and/or feature is damaged and the specific types of damages. For example, if the search criteria contains 8″ drilling motor from rig 123 in the year of 2016, then the pie chart will show what are the damages that have been recorded and how often of those damages for an 8″ drilling motor that were used on rig 123 over the year of 2016. The types of damage for this component may include crack, damaged thread, eccentric wear, etc. By narrowing the search criteria to include the mandrel, for example, the result may show the damages record for an 8″ drill motor mandrel that were used on rig 123 over the year of 2016.

Another vantage point of inspected damages is to measure the components and/or features damages according to the search criteria received from the user. A bar chart may be used to show all components and their damage count and percentage of the damages. This allows management or the manufacturer to see what components have the most of any particular damages. For example, if the search criteria contains crack damage and a motor asset type, then the bar chart will show which motor components have crack damage and their percentage of occurrence. This information would help the manufacturer to identify possible issues in product liability and modify their product design, manufacturing process, or raw material to be better able to withstand cracking on future products. For operators, this analysis together with drilling information can provide clues to improve drilling processes, e.g., cracking may occur more or less in directional drilling under certain depth and through certain geographical formations, or certain setup of bottom hole assemblies may apply more stress on the drill string, etc.

Inspection frequencies analysis determines how many times for a particular items are being inspected for a period of time. It is an important view at a higher level for all products. With a column chart, the analysis module ranks the top x number of inspected items during a specified period of time. This data enables management to know how long or how many drilling jobs can certain types of assets be used and how often those items have been inspected. For example, larger drilling motors may last longer than a smaller drilling motor because smaller drilling motors tend to be used in deeper downhole situations, or certain type of drill pipe grade last longer than others.

Similar to inspection frequencies, reliability and life-expectancy can be measured by the accumulated number of hours in service or below-rotary-table (BRT) hours. Drilling products' service hours are measured by the time that an item stayed downhole. By entering the BRT hours on each inspection, the inspection system will capture the time for all items over their life-time. By analyzing the service hours for each item against other drilling information can provide a good projection of certain type of item when use in certain type of formation and equipment.

During inspection, inspector can add additional repair or cleaning services to the job in an as needed basis. Additional services may include recut/rethreading, reface, straightening, internal cleaning, serialization, hard banding, bucking, etc. By analyzing the probability of these added services for certain type of inspection with other drilling information will help management to enable better staff planning, inventory movement optimization, and machine or facility capacity planning to handle each type of inspection. Efficiently handle additional services will significantly improve inspection throughput and generating more revenue. Items from certain formation may constitute certain type of damages and therefore require certain type of services. For example, drill pipe from deeper well may incur more thread damages due to more frequent tripping in/out of a well; therefore, refacing or even recutting may be required for high percentage of drill pipe.

Measurements of components and features are recorded during inspection such as wall thickness, outer diameter, inner diameter, bevel diameter, length, etc. With serial number, system can provide a percentage of deterioration or changes of measurements from each inspection. This information is very useful for asset owner to better plan the inspection, maintenance, and purchasing of replacement assets. This information also allows rental companies to estimate the life expectancy of their rental assets and able to determine the drilling practice of their clients, if abusing the assets. Each inspection captures the actual begin and finish date and time of a work order, and the inspected and serviced quantities, and other information. This information allows the analysis module to measure the estimated time for each inspected item, type of asset, inspector, and the workload for that location.

Different types of inspections and assets are recorded from inspections over time. The analysis module is able to report what asset types and/or inspection types are done most in any period of time. Together with captured inspection revenue and inspector hours spent on each job, the system is able to rank the profitability of each product line and shows any product lines that are lacking behind. This information is very useful for sales and marketing to emphasize on profitable product lines and realign their marketing efforts. Management can use this information to better position their operations and streamline workflows.

The described analysis methodology consists of three software system processes: (1) data collection, (2) data mining, and (3) data analysis. Data collection is done by the suite of inspection systems, TraxPortal and Intellispect systems. Inspection information is captured at the smallest discrete level; i.e. box connection of drill pipe, stator body of a drilling motor, etc. Measurements are recorded at the unit of measurement of choice and always preserve the significant digits from the inspector; however, the system is able to convert between Imperial and Metric systems. When analyzing data, the system ensures a unified unit of measurements is used and convert all measurements accordingly. As for recording damages, inspection software has a list of predefined damage codes that are being used among field software and central cloud based systems. By standardizing the damage codes and measurements, data can be aggregated, analyzed, and compared in the analysis module.

Data mining contains sets of business rules or formulas to be applied to certain datasets for easy to understand and measurable results. Data mining is mostly done at the backend of the system and closer to the reporting database. Scheduled data analysis jobs will be run against production data during off hours to aggregate and analyze data that will be pushed into reporting database or data warehouse. Data from different inspection types and data formats are translated into a unified analysis format.

Data analysis is a set of predefined rules plus user selectable parameters that applied to the unified analysis data for the final results that include but not limited to charts, graphs, and data tables. User is able to select different parameter values for different types of analysis for generating desired results. A list of predefined analysis processes are stored in the system and the analysis module invokes different analysis logics and formula based on user inputs.

Inspection Analysis Processes:
1. Inspected Damages
a. Search and retrieve a subset of data based on user's search parameters.
b. Create a list of damages from the search result.
c. Count the number of occurrences of damages in the damage list.
d. Calculate the percentage of the damages.
e. Display a graph or chart of the damages and their percentages.
2. Inspection Frequencies
a. Search by date range, inspection type and/or asset type.
b. Create a list of unique inspections by their work order numbers and asset serial numbers.
c. Count how many times the assets have been inspected within the given date range.
d. Display a graph or chart of unique assets by work order numbers and serial numbers with inspection counts and first and last inspections done for each item.
3. Reliability and Life-Expectancy
a. Search data by user's search parameters.
b. Sum up the below-rotary-table (BRT) hours or in-service hours for each unique asset's components based on the reported in-service hours from the inspection work orders.
c. Display and rank assets and their components in-service hours.
d. Allow user to drill-down for the in-service hours of the components from the corresponding assets.
e. Identify and display components that have been replaced for the same asset; i.e. a rotor of motor 123 have been replaced within the reporting date range.
4. Additional Services Rendered
a. Group additional services by asset, inspection, company division, and customers.
b. Count additional services by service types for each assets' components.
c. Display percentage of service types by correlating with asset, inspection, company division, and/or customers.
d. Create service type trends for each of the correlated views.
5. Component Deterioration Over Time
a. Search and retrieve a list of assets or components that belong to the same asset owner or customer with same asset types and sizes for a date range.
b. Group assets or components by serial numbers and sorted by inspection dates.
c. Calculate the differences of same measurements between inspection work orders.
d. Calculate percentage of changes for each measurement.
e. Create trends of measurement changes of an asset or component for all searched items.
f. Rank measurement deviations and identify asset or component with deviation gaps.
6. Operation Efficiency
a. Search data by inspection type and/or company division.
b. Calculate inspection times by assets or components.
c. Calculate additional service times by asset or components.
d. Rank inspection and additional service throughputs by company divisions and inspectors.
e. Display graph or chart of ranking.
7. Product Line Return on Investment
a. Calculate revenue from different inspection type and/or asset type.
b. Calculate revenue from additional services applied to the inspections above.
c. Calculate inspection and service times and number of inspector and helpers per job.
d. Apply an estimated cost per inspector/helper by company division.
e. Compare the total revenue-cost ratio for each inspection type and/or asset type.
f. Rank profitability by inspection, asset type, company division, and inspector.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. A system for storing, interpreting, processing, and displaying heterogeneous data in a database, comprising:
a computer processor configured to access data stored in the database, including data associated with past jobs, historic bids for jobs, jobs in progress, pending jobs, and further comprising processing logic including:
a common data layer configured to manage and store abstracted data in the database, the common data layer comprises a template repository configured for storing user data and a plurality of data-logic templates defining data types, data attributes, and rules for each data type, and rules for data interaction between different data types;
a plurality of rules of a data abstraction layer configured for processing user data stored in the database and handling a user-interface configured for display on a display screen, the data abstraction layer interprets each data field according to the data-logic templates;
an intelligence layer having context sensitive processing logic configured to process user inputs and user data stored in the database according to the data-logic templates and the plurality of rules of the data abstraction layer;
a user interface layer configured to create screens, tabs, and data fields to present the processed data and capture user inputs for the system according to the data-logic templates;
a job management module configured to access the data in the database and create work orders for a job according to the data-logic templates and keep track of status of jobs in progress;
a work order management module configured to access the database and keep track of work orders associated with jobs in progress, including work assignments, work reassignments, work approvals, work rejections, and work completions; and
a trend analysis module configured to access the database and analyze data associated with completed jobs and historic bids for jobs.

2. The system of claim 1 further comprising a sales order subsystem configured to access the database and create a sales order and converting the sales order to a job in response to approval of the sales order, wherein the job includes a plurality of work items and asset types.

3. The system of claim 1 further comprising a billing module configured to access the database and automatically generate invoices for completed work assignments.

4. The system of claim 3 further comprising a notification module configured to automatically notify and request customer approval of generated invoices.

5. The system of claim 1 wherein the data-logic templates are configured to define how different data types are stored and managed in common database tables for different assets and work orders associated with jobs.

6. The system of claim 1 wherein the data-logic templates are configured to define data sets including field names, data types, data attributes, and rules for each data type.

7. The system of claim 1 further comprising different data fields stored in common database tables that are shared by different object types at the common data layer.

8. The system of claim 1 wherein the data abstraction layer is configured to apply data field names, data types, data attributes, and rules to the raw data in common data layer based on predefined data-logic template of a specific asset or work order type.

9. The system of claim 1 wherein the user interface layer is configured to present each data field according to data-logic template definition and how the system validates the user input.

10. The system of claim 1 wherein the common data layer comprises:
a general data section containing key data fields used to identify, locate and interpret detail data sections; and
at least one detail data section containing data-logic defined datasets that can be interpreted by data-logic template definitions.

11. The system of claim 8 wherein the common data layer further comprises data pointers linking the general data section and the at least one detail data section.

12. An oilfield inspection system, comprising:
a computer processor configured to access data stored in the database, including data associated with past inspection jobs, historic bids for inspection jobs, inspection jobs in progress, and pending inspection jobs associated with oilfield equipment, and further comprising processing logic including:
a sales order subsystem configured to provide a web-portal interface to access the database and create a sales order and automatically converting the sales order to a job in response to approval of the sales order, wherein the job includes a plurality of work items and asset types
a job module configured to access the data in the database and create work orders for a job according to a plurality of data-logic templates stored in a template repository defining data types, data attributes, and a plurality of rules for process and interpret each data type, and rules for data interaction between different data types, and keep track of status of jobs in progress;
a work order module configured to access the database and keep track of work orders associated with jobs in progress, including work assignments, work reassignments, work approvals, work rejections, and work completions;
a billing module configured to access the database and automatically generate invoices for completed work assignments according to the data-logic templates and the plurality of rules;
a trend analysis module configured to access the database and analyze data associated with completed jobs and historic bids for jobs; and
a notification module configured to automatically generate and transmit notifications to users according to the data-logic templates.

13. The system of claim 12, wherein the data-logic templates are configured to define how different data types are stored in common database tables for different assets categories and work order types.

14. The system of claim 12, further comprising different data fields stored in common database tables that are shared by different object types at a common data layer.

15. The system of claim 12, further comprising a data abstraction layer configured to apply data field names, data types, data attributes, and rules to the raw data in common data layer based on predefined data-logic template of a specific asset or work order type.

16. The system of claim 12, further comprising a user interface layer configured to present each data field according to data-logic template definition.

17. The system of claim 12, further comprising a user interface layer configured to validate user input according to the data-logic template definition.

18. The system of claim 12, wherein the common data layer comprises:
a general data section containing key data fields used to identify, locate and interpret detail data sections; and
at least one detail data section containing data-logic defined datasets that can be interpreted by data-logic template definitions.

19. The system of claim 16 wherein the common data layer further comprises data pointers linking the general data section and the at least one detail data section.

20. The system of claim 12 wherein the computer processor is further configured to store, process, analyze, and display a plurality of inspection results for every inspected feature for a given work order and inspection type, the computer processor configured to analyze the inspection results across all work order types.

21. The system of claim 12 wherein the computer processor is further configured to retrieve inspection result codes for different inspection types and materials to aggregate the results and damage codes for analysis and graphical representation.

22. The system of claim 12 wherein the computer processor is further configured to store coded inspection results of different features of items, different inspected items, and different inspection work order types to a same set of data fields in a database according to the data-logic templates.

23. The system of claim 12 wherein the computer processor is further configured to enable an unlimited number of inspection result codes to be added and stored in same set of data fields in the same database without requiring modification to existing data structure.

24. The system of claim 12 wherein the computer processor is further configured to store different measurements under different units of measurements for any inspected items using different inspection work order types to the same set of data fields in the same data table.

25. The system of claim 12 further comprising data processing logic to convert and map all measurements of different units of measurements for different inspected items of different inspection work order types to a set of standard measurements for analysis, comparison, and graphical representation.

26. A method of storing, interpreting, displaying, and processing heterogeneous data related to assets and work orders associated with jobs stored in a database comprising:
providing data-logic templates which defines how data types are stored and interpreted in common database tables for different assets and work orders, data sets that include field names, data types, data attributes, and rules for each types of assets or work orders, and rules for data interaction between work order data and asset data;
storing data associated with jobs at different stages of progress according to the data-logic template definitions in the database;
interpreting data stored in the database according to the data-logic template definitions;
processing data stored in the database according to the data-logic template definitions;
displaying data stored in the data fields of the database according to the data-logic template definitions; and
receiving and validating user input according to the data-logic template definitions.

27. The method of claim 26, wherein storing data comprises storing data in a common data layer including a general data section containing key data fields used to identify, locate and interpret detail data sections, and at least one detail data section containing data-logic defined datasets that can be interpreted by data-logic template definitions.

28. The method of claim 26, further comprising encoding and decoding data stored in a common data layer according to the data-logic template definitions.

29. A method for storing, interpreting, displaying, and processing heterogeneous data associated with a plurality of jobs at various stages of progress comprising:
providing a plurality of data-logic templates defining data types, data attributes, and rules for data interaction between different data types;
receiving and validating user inputs according to the plurality of data-logic templates;
storing data associated with a plurality of jobs at various stages of progress in data fields in common database tables defined by the plurality of data-logic templates;
Interpreting the stored data according to the plurality of data-logic templates;
context sensitive processing of user inputs and data according to the plurality of data-logic templates;
creating and displaying screens, tabs, and data fields to present data according to the data-logic templates;
accessing the stored data and keeping track of the status of jobs in progress;
accessing the stored data and keeping track of work orders associated with jobs in progress, including work assignments, work reassignments, work approvals, work rejections, and work completions; and
accessing the stored data and analyzing the stored data associated with completed jobs.

30. A computerized method comprising:
receiving search parameters from a user;
searching a database of oil-country-tubular-goods (OCTG), drill tools, and bottom-hole-assemblies (BHA) inspection equipment data and generating search results including a subset of data from the database in response to the user's search parameters:
determining the usage of the equipment per inspected items;
determining the maintenance and replacement costs of the equipment from historic maintenance and purchasing data;
determining the average life expectancy of the equipment from historic data;
prorating the maintenance costs of the equipment over the items that were inspected using those equipment between last maintenance date and the expected next maintenance date;
prorating the equipment replacement costs over the average numbers of inspected items during the life expectancy of those equipment;
applying the prorated equipment usage costs to inspection work orders according to their numbers of items;
calculating the operation costs of the equipment by equipment types, inspection work order types, company division, and inspection lines; and
displaying a graphical representation of the operation costs.
